(19) United States
(12) Patent Application Publication
(10) Pub. No.: US 2013/0106384 A1
(43) Pub. Date: May 2, 2013

(54) VOLTAGE CONVERTING CIRCUIT

(71) Applicants: TING GE, Shenzhen City (CN); YING-BIN FU, Shenzhen City (CN); YA-JUN PAN, Shenzhen City (CN)

(72) Inventors: TING GE, Shenzhen City (CN); YING-BIN FU, Shenzhen City (CN); YA-JUN PAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/590,058

(22) Filed: Aug. 20, 2012

(30) Foreign Application Priority Data
Oct. 31, 2011 (CN) 201110337335.9

(51) Int. Cl. G05F 1/565

(52) U.S. Cl. 323/286

(57) ABSTRACT

A voltage converting circuit includes a power supply, a buck circuit a buck circuit electronically connected to the power supply, a current detection circuit electronically connected to the buck circuit and a PWM controller electronically connected to the buck circuit and the current detection circuit. The buck circuit is configured for converting a source voltage and a source current of the power supply to an output voltage and an output current driven by the PWM controller. The current detection circuit is configured for detecting a current variation of the output current. The PWM controller configuring for receiving the current variation of the output current, and driving the buck circuit to increase the output voltage when the output current is decreased, and driving the buck circuit to decrease the output voltage when the output current is increased.

### BACKGROUND

1. Technical Field

The exemplary disclosure generally relates to voltage converting circuits, particularly to a voltage converting circuit having a Vdroop function.

2. Description of Related Art

Some direct current to direct current (DC-to-DC) voltage converting circuits of a central processor unit (CPU) have a Vdroop function. That is when a load driven by the voltage converting circuit is increased, an output current of the voltage converting circuit is correspondingly increased, while an output voltage of the voltage converting circuit is correspondingly decreased because of the increased output current. In other words, the output voltage of the voltage converting circuit experiences a significant drop voltage when the voltage converting circuit goes from an idle state to a load state. This Vdroop function of the voltage converting circuit can prevent an extremely high output voltage caused by a transient increase of the output current from damaging the load driven by the voltage converting circuit.

A typical voltage converting circuit having Vdroop function usually detects a voltage variation of the output voltage, and then adjusts the output voltage when the output voltage is changed. However, the aforementioned method cannot rapidly response to the variation of the output current caused the of the output voltage. Thus, the typical voltage converting circuit cannot rapidly adjust the output voltage according to the of the output current.

Therefore, there is room for improvement within the art.

### BRIEF DESCRIPTION OF THE DRAWINGS

Many aspects of the embodiments can be better understood with reference to the drawings. In the drawings, the emphasis is placed upon clearly illustrating the principles of the disclosure.

FIG. 1 is a block diagram of an exemplary embodiment of a voltage converting circuit.

FIG. 2 is a schematic circuit diagram of the voltage converting circuit showed in FIG. 1.

### DETAILED DESCRIPTION

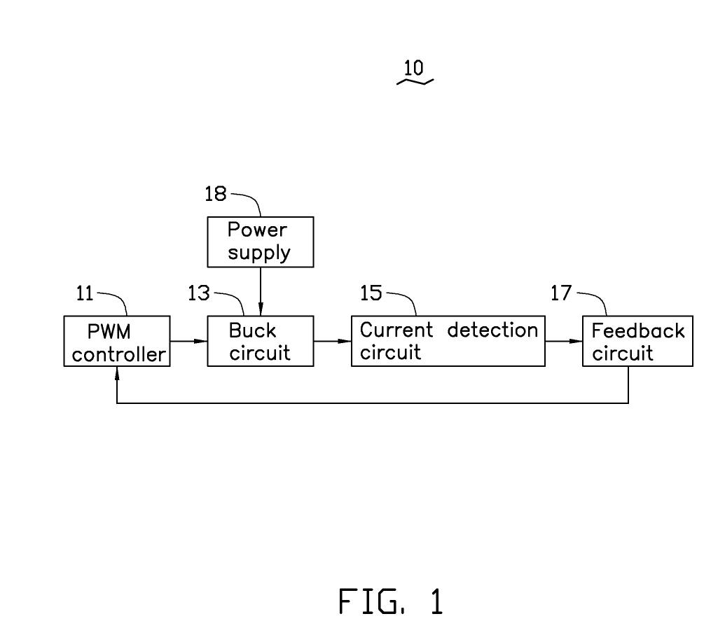

FIG. 1 is a block diagram of an exemplary embodiment of a voltage converting circuit 100. The voltage converting circuit 100 is a DC-to-DC voltage converting circuit capable of powering electronic components such as a processor or a memory, for example. The voltage converting circuit 100 includes a pulse width modulation (PWM) controller 11, a buck circuit 13, a current detection circuit 15, a feedback circuit 17, and a power supply 18. The PWM controller 11 is configured for driving the buck circuit 13 to convert a source voltage and a source current of the power supply 18 to an output voltage Vout and an output current Iout. The current detection circuit 15 is configured for detecting current variation of the output current Iout of the buck circuit 13. The feedback circuit 17 is configured for feeding back the current variation of the output current Iout to the PWM controller 11. The PWM controller 11 is further configured for controlling the buck circuit 13 to compensate for variation of the output voltage so as to stabilize the output voltage, in detail, the PWM controller 11 controls the buck circuit 13 to increase the output voltage Vout when the output current Iout is decreased, and controls the buck circuit 13 to decrease the output voltage Vout when the output current Iout is increased.

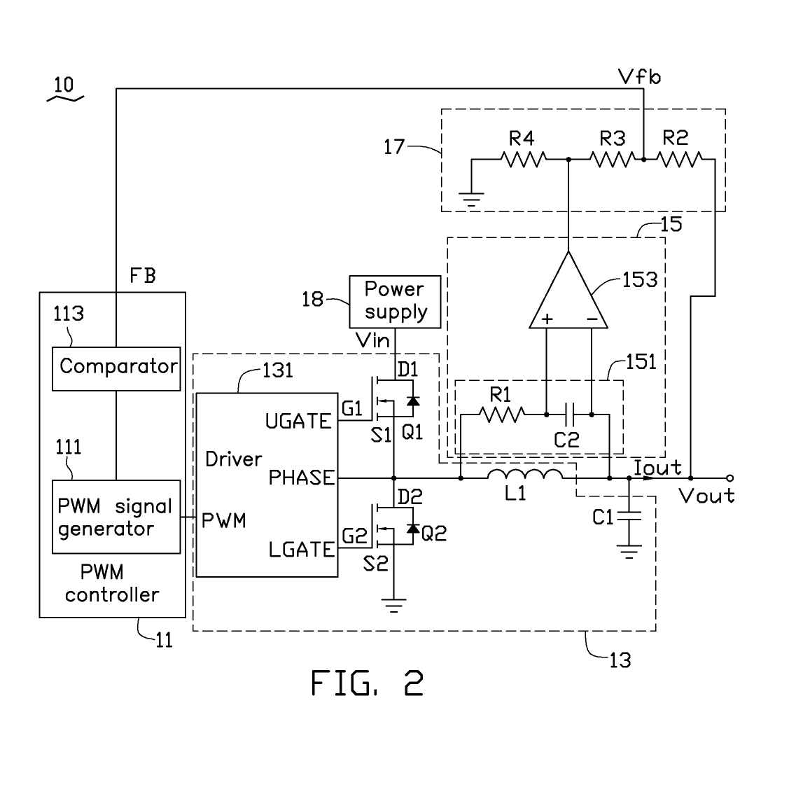

FIG. 2 is a schematic circuit diagram of the voltage converting circuit showed in FIG. 1. The PWM controller 11 is an integrated chip, and includes a PWM signal generator 111, a comparator 113 electronically connected to the PWM signal generator 111, and a feedback pin FB electronically connected to the comparator 113. The PWM signal generator 111 generates a PWM signal and outputs the PWM signal to the buck circuit 13, thereby driving the buck circuit 13 to convert a source voltage and a source current of the power supply 18 to the output voltage Vout and the output current Iout. The comparator 113 receives a feedback voltage Vfb from the feedback circuit 17 via the feedback pin FB, compares the feedback voltage Vfb with a reference voltage, and outputs a corresponding comparison result to the PWM signal generator 111. When the feedback voltage Vfb is higher than the reference voltage, the PWM signal generator 111 decreases a duty cycle of the PWM signal, thereby driving the buck circuit 13 to decrease the output voltage Vout, when the feedback voltage Vfb is lower than the reference voltage, the PWM signal generator 111 increases the duty cycle of the PWM signal, thereby driving the buck circuit 13 to increase the output voltage Vout.

The buck circuit 13 includes a driver 131, a first metal oxide semiconductor field effect transistor (MOSFET) Q1, a second MOSFET Q2, an inductor L1 and a first capacitor C1. The driver 11 is configured for providing control signals to the first and second MOSFET Q1, Q2 according to the PWM signal. The driver 11 has an input pin PWM, a first output pin UGATE, a second output pin LGATE, and a phase pin PHASE.

The input pin PWM is electronically connected to the PWM signal generator 111 to receive the PWM signal. The first output pin UGATE and the second output pin LGATE are respectively electrically connected to a gate G1 of the first MOSFET Q1 and a gate G2 of the second MOSFET Q2. The power supply 18 is electrically connected to a drain D1 of the first MOSFET Q1. A source S1 of the first MOSFET Q1 is electrically connected to a drain D2 of the second MOSFET Q1. A source S2 of the second MOSFET Q1 is grounded. The phase pin PHASE is electrically connected to a node between the source S1 of the first MOSFET Q1 and the drain D2 of the second MOSFET Q2. The inductor L1 and the first capacitor C1 are connected to the node between the source S1 of the first MOSFET Q1 and the drain D2 of the second MOSFET Q2 and the ground.

The driver 11 generates control signals in response to the received PWM signal and transmits control signals to the gates D1, D2 of the first and second MOSFET Q1, Q2. The control signals control the first MOSFET Q1 and the second MOSFET Q2 to be alternately turned on and off. When the first MOSFET Q1 is turned on and the second MOSFET Q2 is turned off, the inductor L1 stores energy, and the first capacitor C1 is charged by the power supply 18 via the first MOSFET Q1. When the first MOSFET Q1 is turned off and the second MOSFET Q2 is turned on, the inductor L1 releases energy, and the first capacitor C1 is discharged via the second MOSFET Q2. In this way, the output voltage Vout and the output current Iout is generated between the inductor L1 and the first capacitor C1 and is forward to a load (not shown). Since a switching frequency of the first MOSFET Q1 and the second MOSFET Q2 is high, the output voltage Vout is approximately a direct voltage with a minimal alternative voltage component, and the output current is approximately a direct current with a minimal alternative current component. The voltage value of the output voltage Vout can be regulated by changing duty cycle of the PWM signal.

The current detection circuit 15 includes a voltage sensor 151 and an operational transconductance amplifier (OTA) 153. The voltage sensor 151 includes a detecting resistor R1 and a detecting capacitor C2. The detecting resistor R1 and the detecting capacitor C2 are connected in series, and are then connected to the inductor L1 in parallel. A positive input terminal of the OTA 153 is electronically connected to a node between the detecting capacitor C2 and the detecting resistor R1, a negative input terminal of the OTA 153 is electronically connected to a node between the detecting capacitor C2 and the inductor L1, an output terminal of the OTA 153 is electronically connected to the feedback circuit 17.

The feedback circuit 17 includes a first voltage dividing resistor R2, a second voltage dividing resistor R3 and a first resistor R4, all of which are electronically connected between the ground and the node between the inductor L1 and the first capacitor C1 in series. A node between the second voltage dividing resistor R3 and the first resistor R4 is electronically connected to the output terminal of the OTA 153. A node between the first and second voltage dividing resistors R2, R3 is electronically connected to the feedback pin FB of the PWM controller 11. An electric potential of the node between the first and second voltage dividing resistors R2, R3 is the feedback voltage Vfb.

The inductor L1 has a DC resistance DCR. The voltage potential drop of the inductor L1 equals a product of the DCR and the output current Iout. The voltage sensor 15 is configured for detecting current flowing through the inductor L1 (i.e., equivalent of the output current Iout) by detecting voltage of the inductor L1. The OTA 153 is configured for transforming the voltage of the inductor L1 to a corresponding current signal, which is then forward to the feedback circuit 17 to generate the feedback voltage Vfb.

In particular, the current signal output from the output terminal of the OTA 153 is generated according to an electric potential difference between the positive input terminal and the negative input terminal of the OTA 153. The electric potential difference between the positive input terminal and the negative input terminal of the OTA 153 substantially equals an voltage potential drop of the detecting capacitor C2. The current signal increases or decreases correspondingly when the electric potential difference between the positive input terminal and the negative input terminal of the OTA 153 increases or decreases. According to the inherent characteristics of RLC circuits, the voltage potential drop of the detecting capacitor C2 depends on an voltage potential drop of the DCR of the inductor L1, an inductance of the inductor L1, a capacitance of the detecting capacitor C2, and a resistance of the detecting resistor R1. When these parameters are adjusted, time constant of the inductor L1 and time constant of the voltage sensor 151, that is a product of the time constants of the detecting resistor R1 and the detecting capacitor C2, can be correspondingly adjusted.

According to the aforementioned method, in this embodiment, the capacitance of the detecting capacitor C2 and the resistance of the detecting resistor R1 are adjusted to ensure that the time constant of the inductor L1 equals the time constant of the voltage sensor 151, at this time, the voltage potential drop of the detecting capacitor C2 equals the voltage potential drop of the inductor L1. Thus, the voltage potential drop of the detecting capacitor C2 and the voltage potential drop of the inductor L1 are changed synchronously.

In use, if the load driving by the voltage converting circuit 10 is increased, the output current Iout, that is, the current flowing through the inductor L1 is increased correspondingly, causing the voltage potential drop of the inductor L1 is increased. For the reasons detailed above, the voltage potential drop of the detecting capacitor C2 is increased to cause the current signal output from the OTA 153 is increased, such that the feedback voltage Vfb detected by the feedback pin FB of the PWM controller is increased correspondingly. If the feedback voltage Vfb is higher than the reference voltage, the PWM signal generator 111 decreases the duty cycle of the PWM signal to drive the buck circuit 13 to decrease the output voltage Vout, thereby decreasing the feedback voltage Vfb to make the feedback voltage Vfb to equal the reference voltage. In this way, the output voltage Vout can be prevented from becoming excessively high and damaging the load driven by the buck circuit 13. The voltage converting circuit 10 can real-timely and accurately adjust the output voltage Vout according to the current variation of the output current Iout.

Similarly, if the load driving by the voltage converting circuit 10 is decreased, the current flowing through the inductor L1 is decreased correspondingly, causing the voltage potential drop of the DCR of the inductor L1 to decrease. The voltage potential drop of the detecting capacitor C2 is decreased to cause the feedback voltage Vfb detected by the feedback pin FB of the PWM controller to decrease correspondingly. If the feedback voltage Vfb is lower than the reference voltage, the PWM signal generator 111 increases the duty cycle of the PWM signal to drive the buck circuit 13 to increase the output voltage Vout, thereby increasing the feedback voltage Vfb to make the feedback voltage Vfb to equal the reference voltage.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A voltage converting circuit, comprising:
a power supply;
a buck circuit electronically connected to the power supply and configured for converting a source voltage and a source current of the power supply to an output voltage and an output current driven by the PWM controller;
a current detection circuit electronically connected to the buck circuit and configured for detecting a current variation of the output current; and
a pulse width modulation (PWM) controller electronically connected to the buck circuit and the current detection circuit, the PWM controller configuring for receiving the current variation of the output current, driving the buck circuit to increase the output voltage when the output current is decreased, and driving the buck circuit to decrease the output voltage when the output current is increased.

2. The voltage converting circuit as claimed in claim 1, wherein the buck circuit comprises an inductor, a first capacitor, and a driver, the driver is electronically connected to the PWM controller, the inductor and the first capacitor is electronically connected between the driver and the first capacitor, and the capacitor is grounded.

3. The voltage converting circuit as claimed in claim 2, wherein the PWM controller generates and transmits a PWM signal to the driver, the driver controls the inductor to alternately store energy and release energy, and controls the first capacitor to be alternately charged and discharged according to the PWM signal, thereby generating the output voltage and the output current outputted a node between the inductor and the first capacitor.

4. The voltage converting circuit as claimed in claim 3, wherein the PWM controller adjusting the output voltage by adjusting a duty cycle of the PWM signal.

5. The voltage converting circuit as claimed in claim 3, wherein the buck circuit further comprises a first metal oxide semiconductor field effect transistor (MOSFET) and a second MOSFET, the first and second MOSFETs are electronically connected to the driver, a gate of the first MOSFET and the gate of the second MOSFET are electronically connected to the driver, a drain of the first MOSFET is electronically connected to the power supply, a source of the first MOSFET is electronically connected to a drain of the second MOSFET, and a source of the second MOSFET is grounded, the inductor and the first capacitor are electronically connected between the ground and a node between the source of the first MOSFET and the drain of the second MOSFET in series, the driver controls the first and second MOSFETs to be alternately turned no and off, to alternately charge and discharge the first capacitor.

6. The voltage converting circuit as claimed in claim 1, wherein the current detection circuit comprises a voltage sensor and a operational transconductance amplifier (OTA), the voltage sensor is configured for detecting voltage of the inductor, the OTA is configured for transforming the voltage of the inductor to a corresponding current signal, the current signal increases or decreases correspondingly when the voltage of the inductor increases or decreases.

7. The voltage converting circuit as claimed in claim 6, wherein the voltage sensor comprises a detecting resistor and a detecting capacitor, the detecting resistor and detecting capacitor connected in series and connected to the inductor in parallel, a positive input terminal of the OTA is electronically connected to a node between the detecting capacitor and the detecting resistor, a negative input terminals of the OTA are electronically connected to a node between the detecting capacitor and the inductor, an output pin of the OTA outputs the current signal.

8. The voltage converting circuit is claimed in claim 7, wherein a time constant of the inductor equals a product of a time constants of the detecting resistor and the detecting capacitor, a voltage potential drop of the detecting capacitor equals the voltage potential drop of the inductor.

9. The voltage converting circuit as claimed in claim 6, further comprising a feedback circuit electronically connected to the OTA and the PWM controller, wherein the feedback circuit is configured for feeding back a feedback voltage to the PWM controller according to the current variation of the current signal.

10. The voltage converting circuit as claimed in claim 9, wherein the PWM controller drives the buck circuit to decrease the output voltage when the feedback voltage is higher than a reference voltage, and drives the buck circuit to increase the output voltage when the feedback voltage is lower than the reference voltage.

11. The voltage converting circuit as claimed in claim 9, wherein the feedback circuit comprises a first voltage dividing resistor, a second voltage dividing resistor and a first resistor, all of which are electronically connected between a node between the inductor and the first capacitor and the ground in series, a node between the second voltage dividing resistor and the first resistor is electronically connected to the OTA to receive the current signal, a node between the first and second voltage dividing resistors is electronically connected to the PWM controller, an electric potential of the node between the first and second voltage dividing resistors is the feedback voltage.
